(19) United States
(12) Patent Application Publication
(10) Pub. No.: US 2008/0128468 A1
(43) Pub. Date: Jun. 5, 2008

(54) Magazine assembly for long and short nails

(75) Inventor: Yi-Kuan Lee, Ta-Li City (TW)

Correspondence Address: CHARLES E. BAXLEY, ESQ., 90 JOHN STREET, THIRD FLOOR, NEW YORK, NY, 10038, US

(73) Assignee: Samson Power Tool Co., Ltd.

(21) Appl. No.: 11/821,282

(22) Filed: Jun. 22, 2007

(30) Foreign Application Priority Data
Nov. 30, 2006 (TW) 095144349

(51) Int. Cl. B25C 5/16

(52) U.S. Cl. 227/120

(57) ABSTRACT

A magazine assembly for a pneumatic nailer includes a first end wall and a second end wall, a side panel and a cover pivotably connected to the magazine are connected between the first and second end walls. A plurality of first recessed areas are separated by first guide ribs in the magazine assembly so that the heads of nails are relieved between two adjacent first guide ribs and the shanks are received in the first recessed area. The nails are arranged such that a gap between the second end wall and the tips of the nails are maintained within a range whichever length of nails are used so as to ensure the nails are guided and ejected properly.

### FIELD OF THE INVENTION

The present invention relates to a magazine assembly of a pneumatic nailer and long or short nails can be used in the magazine assembly.

### BACKGROUND OF THE INVENTION

A conventional magazine assembly for a pneumatic nailer 1 is disclosed in FIGS. 1 to 4, and generally includes a nose 10 which includes a passage 101 defined axially therethrough and a slot 102 is defined through a wall of the nose 10, the slot 102 communicates with the passage 101. A magazine 11 is connected to the nose 10 and includes an interior space 102 and a groove 110. The magazine 11 receives nails 4 therein and the heads 40 of the nails 4 are movably engaged with the groove 110 and the shanks 41 of the nails 4 are received in the interior space 102. A pivot 12 is located close to the slot 102 so that a cover 2 is pivotably connected to the pivot 12 and a locking member 3 on the cover 2 can be connected with a recess 113 of the magazine 11 when the cover 2 is in closed position. The nails 4 are sent into the passage 101 one by one via the slot 102. The conventional magazine assembly is designed for a certain length of nails, long nails for example, and the ling nail can be smoothly guided to the passage 101 and a gap between the tip of the long nails and the inside of the magazine 11 is maintained within a small range. By the arrangement, when the long nail is pushed by the piston rod of the nailer, even if the tip of the nail is tilt in the passage 101, the long nail is successfully ejected out from the nose 10. If short nails are used in the magazine assembly, the heads of the short nails are still engaged with the groove 110 but the gap between the tips of the nails and the inside of the magazine assembly is much longer than the gap for long nails. If the short nail in the passage 101 is tilt, the short nail is easily jammed because the tip is likely to hit the inside of the slot.

The present invention intends to provide a magazine assembly for a pneumatic nailer wherein the gap between the tip of the nails and the end wall of the magazine is maintained to be small whichever long or short nails are used.

### SUMMARY OF THE INVENTION

The present invention relates to a magazine assembly for a pneumatic nailer which includes a nose having a passage defined axially therethrough and a slot is defined through a wall of the nose. The magazine assembly is connected to the nose and the nails received in the magazine assembly are sent into the passage via the slot. A pivot is located close to the slot and a cover is pivotably connected to the pivot. The magazine assembly comprises a first end wall and a second end wall, a side panel and the cover are connected between the first and second end walls. An interior space is defined in the magazine assembly and a groove is defined in the first sidewall for receiving heads of long nails. The interior space includes a plurality of first recessed areas which are separated by first guide ribs. The cover includes a locking member which is removably connected with a recess defined in an outside of the magazine assembly. A plurality of second recessed areas are defined in the cover and separated by second guide ribs. The first recessed areas are located to communicate with the second recessed areas and the first and second guide ribs are located corresponding to each other when the cover is mounted between the first and second end walls of the magazine assembly. The heads of short nails are received in adjacent first/second guide ribs to keep a gap between the tips of the short nails and the second end wall within a certain range.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional magazine assembly and short nails are received therein;

FIG. 2 shows that the short nail is jammed in the passage of the nose;

FIG. 3 is a cross sectional view taken along line A-A in FIG. 1;

FIG. 4 shows different lengths of nails are received in the conventional magazine assembly and the cover is located at locked position;

FIG. 5 shows long nails are received in the magazine assembly of the present invention;

FIG. 6 shows short nails are received in the magazine assembly of the present invention;

FIG. 7 shows a cross sectional view taken along line B-B in FIG. 6, and

FIG. 8 shows a top cross sectional view when the short nails are received in the magazine assembly of the present invention.

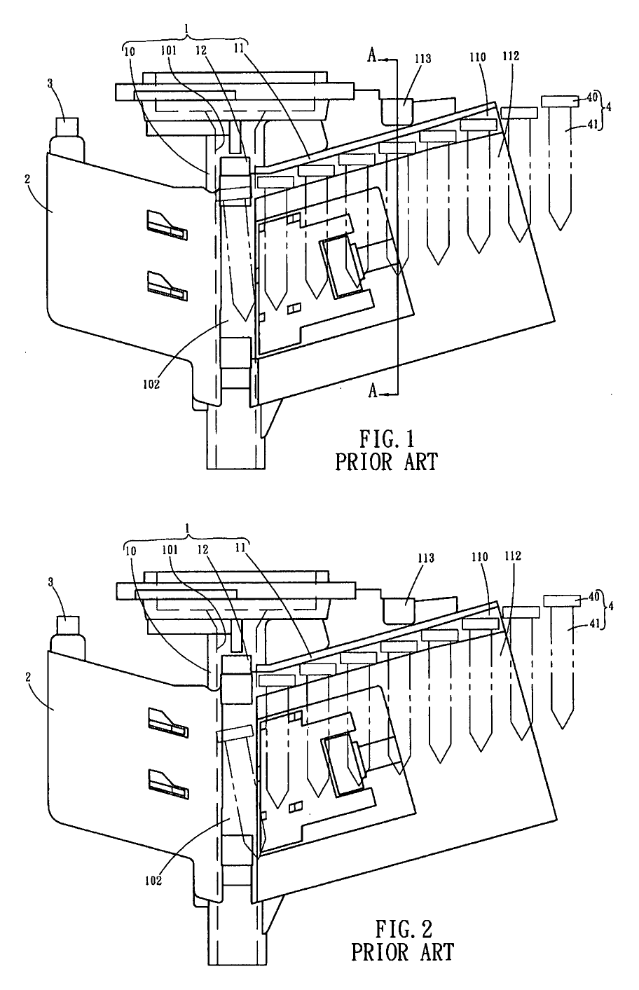

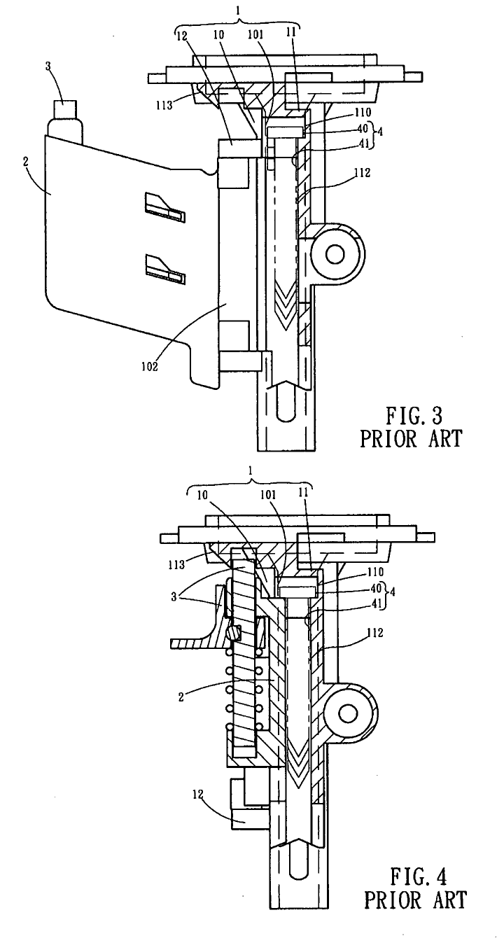

### DETAILED DESCRIPTION OF THE PREFERRED EMBODIMENT

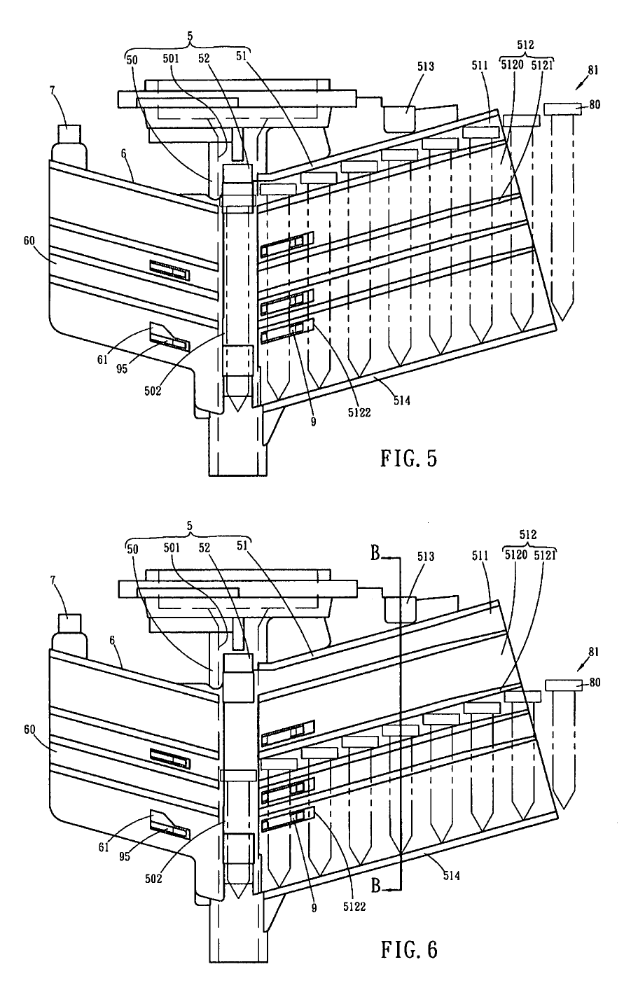

Referring to FIG. 5, the magazine assembly 51 for a pneumatic nailer of the present invention is connected with a nose 50 of the pneumatic nailer and a passage 501 is defined axially through the nose 50. A slot 502 is defined through a wall of the nose 50 so that nails 8 in the magazine assembly 51 are sent into the passage 501 via the slot 502 one by one. A pivot 52 is located close to the slot 502 and a cover 6 is pivotably connected to the pivot 52.

The magazine assembly 51 comprises a first end wall and a second end wall 514, a side panel connected between the first end wall and the second end wall 514, and the cover 6 is also mounted between the first end wall and the second end wall 514. An interior space 512 is defined in the magazine assembly 51 and a groove 511 is defined in the first sidewall, so that long nails 8 as shown in FIG. 5 is received in the magazine assembly 51. The heads 80 of the long nails 8 are engaged with the groove 511 and only a small gap is defined between the tips of the long nails 8 and the second end wall 514. As disclosed, the tips of the long nails 8 are in contact with the second end wall 514. The interior space 512 includes a plurality of first recessed areas 5120 which are separated by first guide ribs 5121. The first recessed areas 5120 and the first guide ribs 5121 are parallel to the second end wall 514 of the magazine assembly 51.

The cover 6 is pivotably connected to the pivot 52 and has a locking member 7 which is removably connected with a recess 513 defined in an outside of the magazine assembly 51. A plurality of second recessed areas 60 are defined in the cover 6 and separated by second guide ribs. The first recessed areas 5120 are located to communicate with the second recessed areas 60 and the first and second guide ribs 5121 are located corresponding to each other when the cover 6 is mounted between the first and second end walls of the magazine assembly 51.

The magazine assembly 51 includes a first elongate recess 5122 defined in an inside of each first recessed areas 5120 and a nail catcher 9 is movably received in each first elongate recess 5122. The cover 6 includes a second elongate recess 61 defined in an inside of each of the second recessed areas 60, a stop 95 is movably received in each second elongate recess 61.

The tips of the long nails 8 are in contact with the second end wall 514 so that when the long nail 8 is sent into the passage 501 and ejected, the tip does not jammed by the periphery of the slot 502.

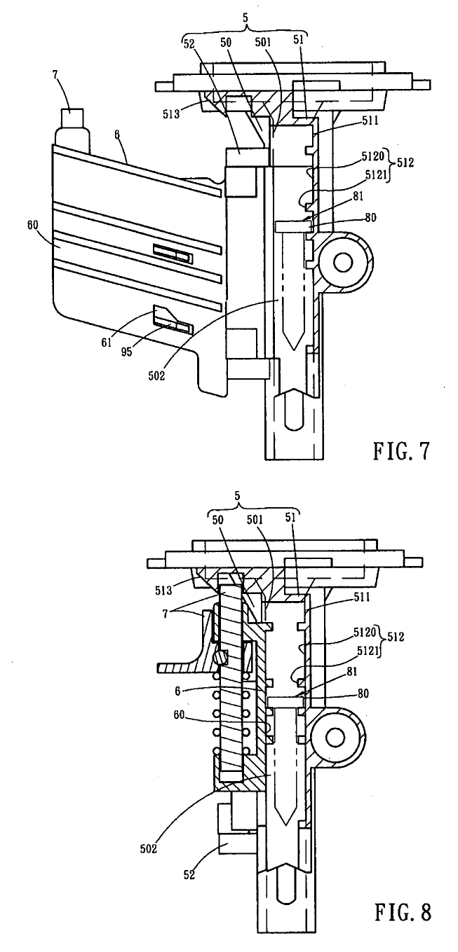

As shown in FIGS. 6 to 8, when using short nails 81 in the magazine assembly 6, the heads 80 of the short nails 81 are located in one of the first recessed areas 5120 and the corresponding second recessed area 60, and guided by the adjacent first guide ribs 5121 and corresponding second guide ribs. By the arrangement, the tips of the short nails 81 are in contact with the second end wall 514 or a gap between the tips of the short nails 81 and the second end wall 514 is within a proper range. This ensures that the short nails 81 can be successfully ejected with jamming.

While we have shown and described the embodiment in accordance with the present invention, it should be clear to those skilled in the art that further embodiments may be made without departing from the scope of the present invention.

What is claimed is:

1. A magazine assembly for a pneumatic nailer which includes a nose having a passage defined axially therethrough and a slot is defined through a wall of the nose, a pivot is located close to the slot, the magazine assembly comprising:
a first end wall and a second end wall, a side panel connected between the first and second end walls, an interior space defined in the magazine assembly and a groove defined in the first sidewall, the interior space including a plurality of first recessed areas which are separated by first guide ribs, the first recessed areas and the first guide ribs being parallel to the second end wall of the magazine assembly, and
a cover is pivotably connected to the pivot and having a locking member which is removably connected with a recess defined in an outside of the magazine assembly, a plurality of second recessed areas defined in the cover and separated by second guide ribs, the first recessed areas located to communicate with the second recessed areas and the first and second guide ribs being located corresponding to each other when the cover is mounted between the first and second end walls of the magazine assembly.

2. The magazine assembly as claimed in claim 1, wherein the magazine assembly includes a first elongate recess defined in an inside of each first recessed areas and a nail catcher is movably received in each first elongate recess.

3. The magazine assembly as claimed in claim 2, wherein the cover includes a second elongate recess defined in an inside of each of the second recessed areas, a stop is movably received in each second elongate recess.
